(19) United States
(12) Patent Application Publication
(10) Pub. No.: US 2010/0278421 A1
(43) Pub. Date: Nov. 4, 2010

(54) EXTRACTING COLORS

(76) Inventor: Marc Andre Peters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/812,049

(22) PCT Filed: Jan. 12, 2009
(86) PCT No.: PCT/IB09/50108

§ 371 Date: Jul. 8, 2010

(30) Foreign Application Priority Data
Jan. 17, 2008 (EP) 08150343.5

(51) Int. Cl. G06K 9/00

(52) U.S. Cl. 382/162

(57) ABSTRACT

A method of processing an image signal comprises receiving an image signal comprising a series of frames, calculating a plurality of dominant colors, over the series of frames, selecting a subset of frames of the image signal, calculating a plurality of dominant colors, over the subset of frames, comparing the dominant colors of the subset of frames to the dominant colors of the series of frames, and determining the dominant color in the subset of frames, with the largest difference from the closest dominant color in the series of frames.

### FIELD OF THE INVENTION

This invention relates to a method and system of processing an image signal.

### BACKGROUND OF THE INVENTION

It is common for people to watch television and engage in other activities that include visual content such as watching DVDs. The user experience with respect to watching such video content will change in the future. The first signs are already visible, for example in the television products of Philips, in which lamps are added to enhance the experience of watching television. This process of adding further devices and additional functionality to augment an entertainment experience such as watching a film is growing. The venture “amBX” (see for example, www.ambx.com) is preparing the next steps to enhance an experience such as watching television even further, by playing scripts, along with the original audio/visual content, containing effect descriptions that could be offered to the user using a suitable augmentation system. Additional devices in the user's entertainment space provide augmentation to the video content.

For example, United States of America Patent Application Publication US2002169817 discloses a real-world representation system which comprises a set of devices, each device being arranged to provide one or more real-world parameters, for example audio and visual characteristics. At least one of the devices is arranged to receive a real-world description in the form of an instruction set of a markup language and the devices are operated according to the description. General terms expressed in the language are interpreted by either a local server or a distributed browser to operate the devices to render the real-world experience to the user. In this way a script is delivered that is used to control other devices alongside the television delivering the original content.

It is necessary however, to author the scripts that will be used to create the additional effects in the additional devices. To assist the authoring process, many applications use content analysis to automate the processes that would otherwise have to be carried out manually. In relation to content creation, for example amBX scripting, well-trained authors go through a movie frame by frame and choose specific frames where they wish to start/stop an additional effect, such as the display of one or more lights. These lighting effects have a color that the author adapts to something (background, explosion, object) in the video sequence.

Content analysis can offer great benefits for the scripting authors. For example shot cuts can automatically be detected giving the authors positions in time where the lights might be changed. Dominant colors can be extracted for each frame in a shot or a selection of sampled frames, from which a set of colors can be proposed that would match the colors in the specific shot or time interval. An example of the latter could be the MPEG 7 dominant color descriptor, which gives up to eight colors for a frame. Other methods for choosing colors can be used as well, for example histograms. The dominant colors give very good suggestions to the authors, especially the ones with a high occurrence rate. However, often the not so obvious colors can be very distinguishing, and can be used to create effects that amaze the viewer. However it is not possible at the present time to detect these interesting colors, in order to propose them to the scripting author.

### SUMMARY OF THE INVENTION

It is therefore an object of the invention to improve upon the known art.

According to a first aspect of the present invention, there is provided a method of processing an image signal comprising: receiving an image signal comprising a series of frames, calculating a plurality of dominant colors, over the series of frames, selecting a subset of frames of the image signal, calculating a plurality of dominant colors, over the subset of frames, comparing the dominant colors of the subset of frames to the dominant colors of the series of frames, and determining the dominant color in the subset of frames, with the largest difference from the closest dominant color in the series of frames.

According to a second aspect of the present invention, there is provided a system for processing an image signal comprising: a receiver arranged to receive an image signal comprising a series of frames, and a processor arranged to calculate a plurality of dominant colors, over the series of frames, to select a subset of frames of the image signal, to calculate a plurality of dominant colors, over the subset of frames, to compare the dominant colors of the subset of frames to the dominant colors of the series of frames, and to determine the dominant color in the subset of frames with the largest difference from the closest dominant color in the series of frames.

According to a third aspect of the present invention, there is provided a computer program product on a computer readable medium for processing an image signal, the product comprising instructions for: receiving an image signal comprising a series of frames, calculating a plurality of dominant colors, over the series of frames, selecting a subset of frames of the image signal, calculating a plurality of dominant colors, over the subset of frames, comparing the dominant colors of the subset of frames to the dominant colors of the series of frames, and determining the dominant color in the subset of frames with the largest difference from the closest dominant color in the series of frames.

Owing to the invention, it is possible to extract automatically, from an image signal, colors in a sequence that are of interest to an author, while going beyond the obvious selection of the most dominant color. The method and system provides, for a given time interval of a video sequence, the comparison of the colors of the frames in that interval to the colors of the whole video sequence, and finds the color or colors in the time interval that differ the most from the dominant colors in the whole sequence. These colors are remarkable colors, and the more they differ from the dominant colors of the sequence, the more interesting they can be to a content author, for example to create amazing effects in amBX scripting.

In one embodiment, the image signal further comprises data comprising color information, and the steps of calculating a plurality of dominant colors include accessing the data. This provides automation of the processing of the colors by using metadata that is present within the image signal, for example in the form of MPEG 7 color information. The alternative to this is that the steps of calculating a plurality of dominant colors include performing an analysis of the color content of the frames. Various methods exist to extract the color(s) from an image frame, for example by using pixel counts of individual colors.

Advantageously, each dominant color comprises a representation in 3-dimensional color space, and the step of determining the dominant color in the subset of frames, with the largest difference from the closest dominant color in the series of frames comprises resolving a Euclidian distance for each dominant color.

Preferably, the method further comprises generating a value, the value relating to the determined dominant color in the subset of frames with the largest difference in color from the closest dominant color in the series of frames, and defining the extent of the difference. In addition to identifying the remarkable color within a sequence of consecutive frames, the method and system can be configured to assign a value to the extent of the difference from the dominant color, which could be used in an automated authoring process, for example. For example, if yellow is detected as the most remarkable color in a frame sequence, then a value relating to the Euclidean distance from the nearest dominant color can be returned as how remarkable the color yellow is in the sequence.

### BRIEF DESCRIPTION OF THE DRAWINGS

Embodiments of the present invention will now be described, by way of example only, with reference to the accompanying drawings, in which:—

FIG. 1 is a schematic diagram of an image frame,

FIG. 2 is a table of colors and color values for the image frame of FIG. 1,

FIG. 3 is a schematic diagram of an image signal,

FIG. 4 is a further schematic diagram of the image signal,

FIG. 5 is a flowchart of a method of processing the image signal,

FIG. 6 is a pair of tables showing dominant colors and color comparisons, and

FIG. 7 is a schematic diagram of a system for processing the image signal.

### DETAILED DESCRIPTION OF THE EMBODIMENTS

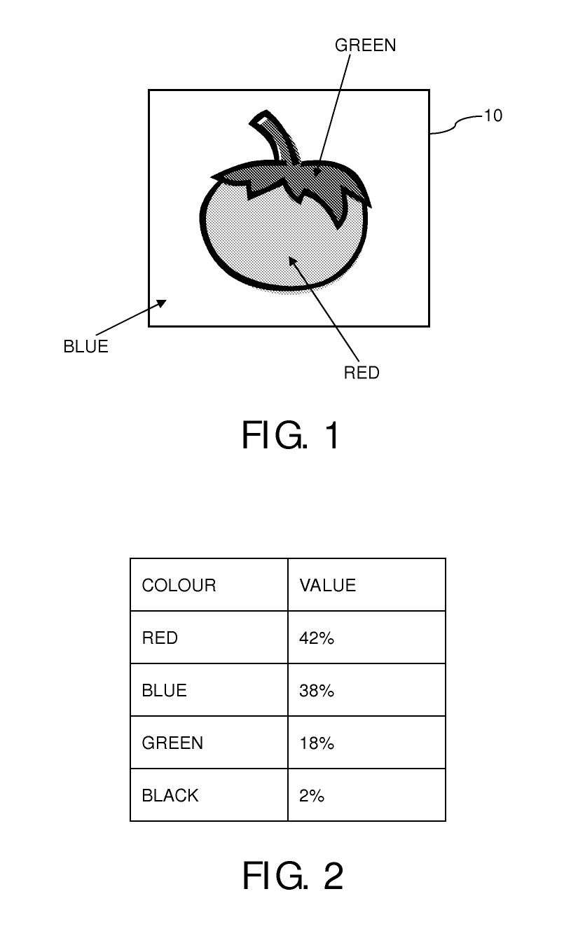

To illustrate the question of color within image frames, an example of an image frame 10 shown in FIG. 1. The frame 10 shows a tomato on a plain background. As the image is reproduced in black and white, the three principal colors within the frame 10, being red, blue and green, are labeled. FIG. 2 summarizes the colors within the frame 10, with a respective color value. The color values are expressed as a percentage of the overall frame 10, but could be absolute values, such as the number of pixels, or be normalized to 1. As can be seen from the table, 2% of the frame 10 of FIG. 1 is black, being made up of the outlines of the red and green components within the frame 10. The frame 10 shown in the Figure has been kept deliberately simple, in order to demonstrate the concept of color and color values within the image frame 10. The values shown in the table of FIG. 2 can be calculated by performing an analysis of the color content within the frame 10, or may be determined from separate data that relates to the content of the frame 10.

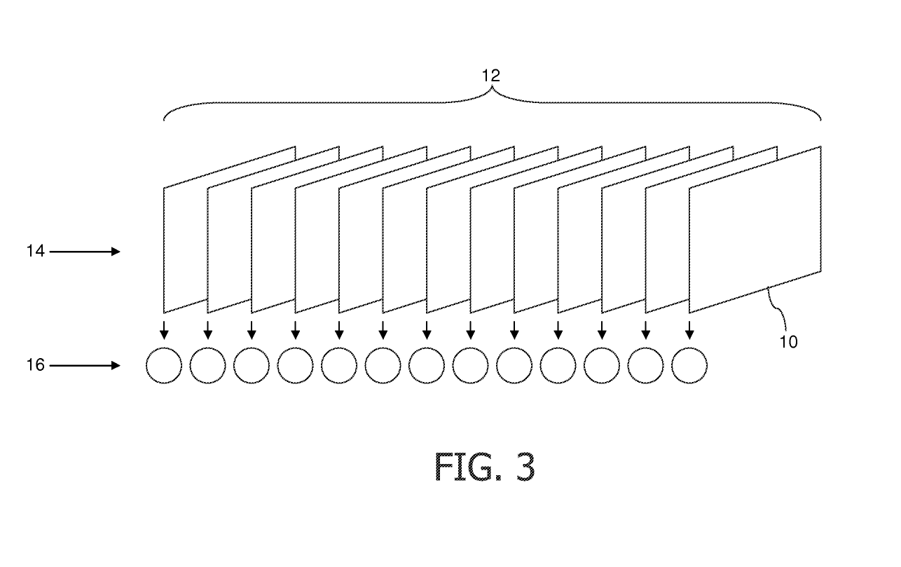

FIG. 3 shows an image signal 12 which comprise a series 14 of the frames 10, and also includes data 16 which comprises color information about each respective frame 10. The series 14 of frames 10 make up a sequence of video. Since it is known to use, for example, twenty-five frames a second to produce video, then the series 14 of frames 10 will comprise a very large number of frames 10 for video content such as a film. Only a small section is shown in FIG. 3, but the principal of the system works for any sequence of image frames 10.

It is necessary to determine a set of dominant colors that are representative for the whole video sequence 14. A good example would be the average of the MPEG 7 dominant color descriptor. The MPEG 7 dominant color descriptor gives up to eight colors that are representative for a frame 10, and is contained within the data 16. The average of such a set of colors for multiple frames 10, can be calculated. Other methods for representing the dominant colors in the series 14 can be used, for example histograms. The average of the video sequence 14 can be computed as the average of the histograms over time. This produces a table similar to that shown in FIG. 2, but in this case the table is representative of the colors and color values across all of the frames 10 within the series 14 of frames 10.

The table in FIG. 2 shows the colors as conventional color labels “red”, “green” etc. In reality, each pixel in the frame 10 has an RGB value, which effectively defines a point in color space (with the three axes of red, green and blue). When determining colors of pixels within a frame 10, if each of the RGB elements is on a scale of 0 to 255, then there are a possible 256³ different colors in the frame 10. In order to return a sensible result for the colors in the frame 10, ranges of the RGB values are used, for example breaking each scale of 0 to 255 into sixteen sub-ranges, 0 to 15, 16 to 31 etc. This allows each pixel to be placed in a range, and reduces the number of different colors. The actual color of the range is taken to be the mid-value, which gives a good enough approximation of all the pixels falling with the range. The dominant colors within the frame 10 are then considered to be the ranges that have the most pixels within them.

This is not the sole way that dominant colors can be calculated for an image frame. This methodology above can be considered as based upon building histograms of the different colors within an image frame, where each histogram represents a predefined color range. Dominant color determination could also simply return the n most numerous colors in the image frame, where n might be 8, as RGB values. This is determining dominant colors based around the actual RGB values of the pixels and is simply looking for the n most commonly occurring RGB values.

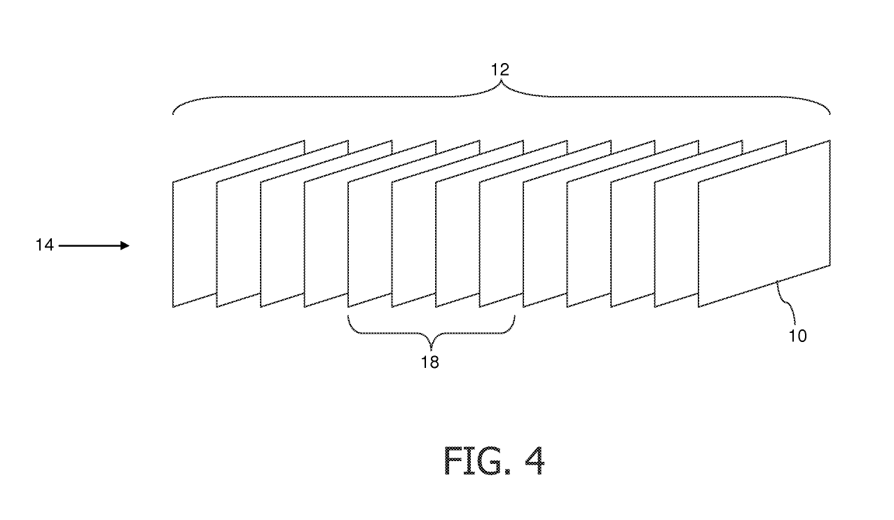

Once the dominant colors have been calculated for the entire series 14 of frames 10, then a selection of a subset 18 of the frames 10 is made, as shown in FIG. 4. This selection could be made on the basis of a variety of different criteria. The selection could be user defined, or could be based on an automatic detection of some internal criteria within the image signal 12. For example, the specific time interval defined by the subset 18 could be a single shot within a film. The same process outlined above with respect to the overall series 14 can now be used on the subset 18, to determine the dominant colors (and their color values) within this subset 18 of frames 10. Once this has been carried out, then it is possible to compare the dominant colors of that time interval 18 with the dominant colors of the whole sequence 14. If this is based upon the use of the MPEG 7 dominant color descriptor, then there would be up to eight colors for the time interval 18 and up to eight colors for the whole sequence 14.

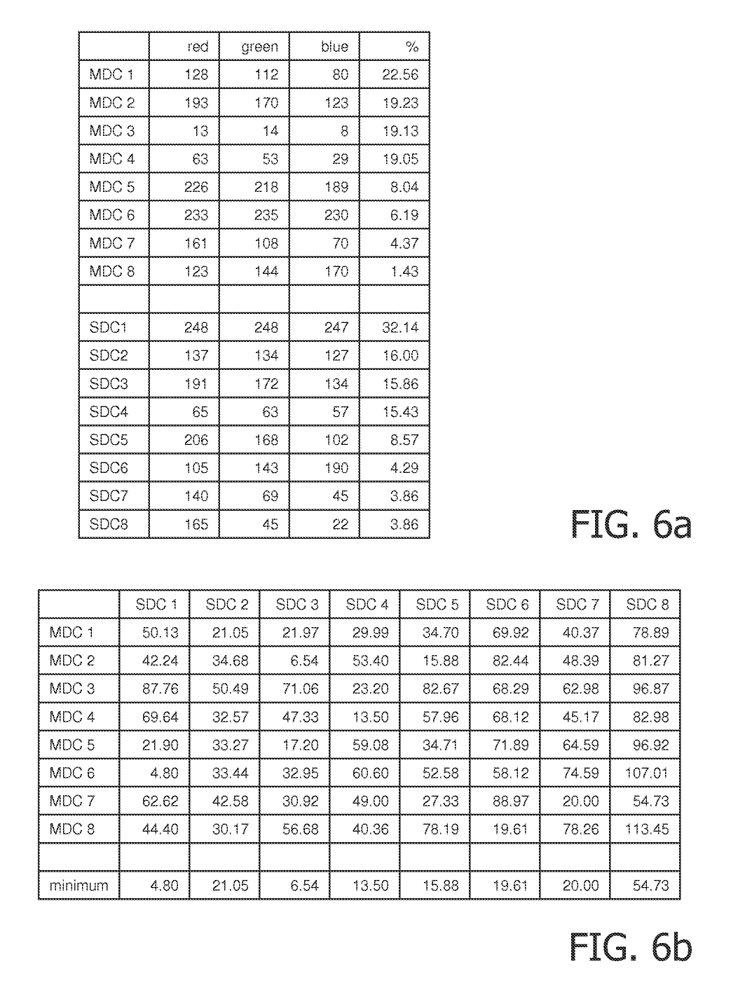

For each of the dominant colors of the specific interval 18, it is then possible to compute the distance to the closest dominant color of the whole sequence 14. This distance measure is ideally computed in a perceptually uniformly color space, for example LUV. To ensure a sensible result, it makes sense to compare the distances in such a way that the distances make sense to human perception. The end result of this comparison process is, for each dominant color in the interval, there is a distance to each color in the set of average dominant colors of the series 14. Next, it is determined which of the dominant colors in the subset 18 has the largest distance to its closest dominant color of the set of average colors for the sequence 14. This is the most remarkable color, since it is perceptually furthest from the average colors of the sequence 14. This will be explained relative to a specific example, below with reference to FIG. 6.

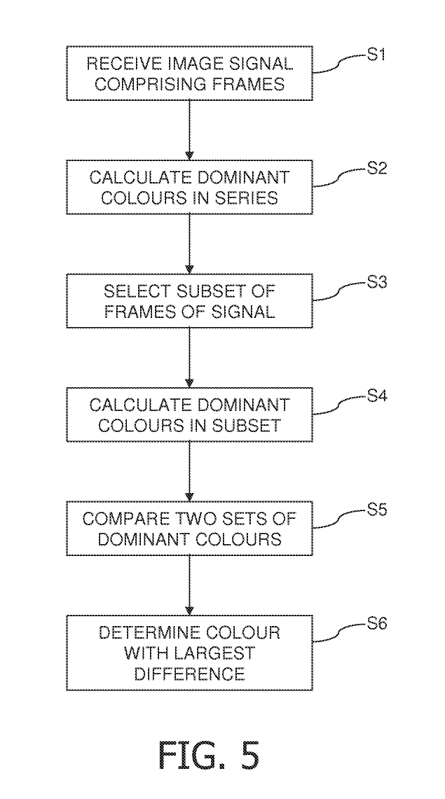

The method of processing the image signal 12 to determine the most remarkable color in a frame sequence 18, relative to the overall content signal 12, is summarized in FIG. 5. The method comprises, at step S1, receiving the image signal 12 comprising a series 14 of frames 10, calculating, step S2, a plurality of dominant colors, over the series 14 of frames 10, selecting, step S3, a subset 18 of frames 10 of the image signal 12, calculating, step S4, a plurality of dominant colors, over the subset 18 of frames 10, comparing, step S5, the dominant colors of the subset 18 of frames 10 to the dominant colors of the series 14 of frames 10, and finally determining, step S6, the dominant color in the subset 18 of frames 10, with the largest difference from the closest dominant color in the series 14 of frames 10.

FIG. 6 shows two sample tables, with the table 6a representing the average dominant colors and their % values of the frames 10 of the entire sequence 14 of the image signal 12, as calculated in step S2 of FIG. 5, and the dominant colors and their % values of the frames 10 of subset 18 of the signal 12, as calculated in step S4. The bottom table 6b shows the comparison of the two sets of dominant colors of table 6a. In table 6a, the eight dominant colors of the overall series 14 are the MDC values (movie dominant color) and the eight dominant colors of the subset 18 are the SDC values (shot dominant color).

If seq₁, . . . , segₙ are the colors representing the whole video sequence 14, and c₁, . . . , cₘ the colors representing the specific time interval, we look for the color that optimizes c_{index} in

Max(i:1≦i≦m:Min(j:1≦j≦n:distance(cᵢ,seqⱼ))) (1)

where the distance is a perceptually uniform distance measure, for example the Euclidian distance in LUV color space. Moreover, the value of (1) is also an indication for how remarkable this color is. The larger the distance from c_{index} to the representative colors of the whole sequence, the more interesting this color could be.

The RGB values of table 6a are converted to LUV values and the Euclidean differences in these LUV values are shown in the table 6b. Effectively each color in the table 6a is a point in color space, and the values in table 6b represent the length of a line drawn between each pair of points. Eight dominant colors in the overall movie are compared to eight dominant colors in the shot, giving sixty-four different pairs of points. The bottom row of the table 6b shows the minimum value for each of the shot colors, that minimum representing the distance from the closest of the movie dominant colors. It can be seen that SDC8 has the largest distance from the closest movie color, the 54.73 value in the minimum row. This is the color that will be determined by the step S6 of FIG. 5.

The methodology of the processing of the image signal 12 can also be applied to a more flexible environment, for example to a sliding window. A video sequence can have large parts that take place in a completely different environment from other parts, and the process can be configured so that there would be comparison of the colors in a specific interval to the colors of a part of the video rather than to the whole video. Another embodiment is to compare a sliding window with a larger sliding window that nevertheless contains the first window. This emphasizes colors that are remarkable on a small scale, even within a shot. With the distance measure defined, the process would return only those colors that are very significantly different. This provides an automated method of filtering out the not so interesting colors and only focusing at the time instances where the most prominent color is most likely of interest.

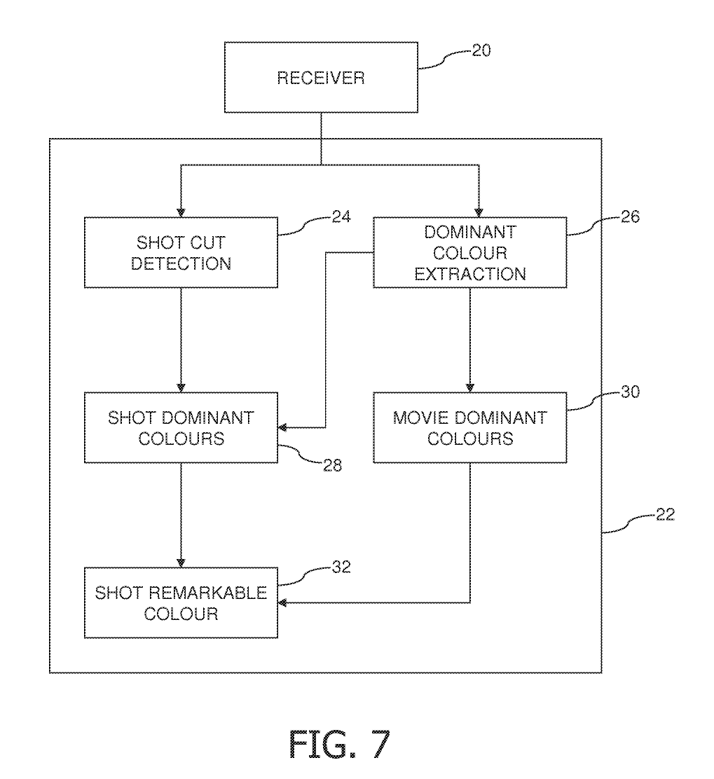

FIG. 7 illustrates schematically a system for processing the image signal 12. The system comprises a receiver 20 and a processor 22. The system could be configured as a dedicated piece of hardware, or could be implemented in a computer program product, which comprises instructions for carrying out the method embodied in FIG. 5. The video signal 12 is analyzed by the processor 22. At block 24, shot cuts within the signal 12 are detected. A shot cut in the film domain is effectively when a change in camera is used, for example from an internal shot to an external shot. Shot cut detection is well-known, and described in, for example, U.S. Pat. No. 5,642,294. At the same time, in parallel, at block 26, the frames 10 of the signal 12 are analyzed for the dominant colors. For each shot there is determined the overall dominant colors using the dominant colors for all (or a sub-sampled set) of the frames 10 designated as being within the shot, at block 28. Similarly, the processor 22 is arranged, at block 30, to determine the dominant colors of the whole movie. For each shot, the dominant colors are compared with the movie dominant colors, at block 32 to identify which one is most distant from the mean (and the extent of the distance).

The above description refers to the use of dominant colors. Also other descriptors like color histograms could be used as a way of determining color values for the colors within one or more frames of the signal 12. In a similar way the use of shots and shot cuts, is only one example of the selection of the subset 18 of frames 10 within the signal 12. For technologies such as amBX, it is advantageous to have stable colors per shot. However it is obvious that the above techniques can be used for any kind of interval. So the shot cut detection is just here as an example. As mentioned above, rather than comparing the dominant colors of a shot or interval to the dominant colors of the whole movie, it is possible to use a sliding window to compare the colors in this sliding window to the larger overlapping window.

1. A method of processing an image signal (12) comprising:
receiving an image signal (12) comprising a series (14) of frames (10),
calculating a plurality of dominant colors, over the series (14) of frames (12),
selecting a subset (18) of frames (10) of the image signal (12),
calculating a plurality of dominant colors, over the subset (18) of frames (10),
comparing the dominant colors of the subset (18) of frames (10) to the dominant colors of the series (14) of frames (10), and
determining the dominant color in the subset (18) of frames (10), with the largest difference from the closest dominant color in the series (14) of frames (10).

2. A method according to claim 1, wherein the image signal (12) further comprises data (16) comprising color information, and the steps of calculating a plurality of dominant colors include accessing the data (16).

3. A method according to claim 1, wherein the steps of calculating a plurality of dominant colors include performing an analysis of the color content of the frames (10).

4. A method according to claim 1, wherein each dominant color comprises a representation in 3-dimensional color space.

5. A method according to claim 4, wherein the step of determining the dominant color in the subset (18) of frames (10), with the largest difference from the closest dominant color in the series (14) of frames (10) comprises resolving a Euclidian distance for each dominant color.

6. A method according to claim 1, and further comprising generating a value, the value relating to the determined dominant color in the subset (18) of frames (10) with the largest difference from the closest dominant color in the series (14) of frames (10), and defining the extent of the difference.

7. A system for processing an image signal comprising:
a receiver (20) arranged to receive an image signal comprising a series (14) of frames (10), and
a processor (22) arranged to calculate a plurality of dominant colors, over the series (14) of frames (10), to select a subset (18) of frames (10) of the image signal, to calculate a plurality of dominant colors, over the subset (18) of frames (10), to compare the dominant colors of the subset (18) of frames (10) to the dominant colors of the series (14) of frames (10), and to determine the dominant color in the subset (18) of frames (10) with the largest difference from the closest dominant color in the series (14) of frames (10).

8. A system according to claim 7, wherein the image signal further comprises data (16) comprising color information, and the processor (22) is arranged when calculating a plurality of dominant colors, to access the data (16).

9. A system according to claim 7, wherein the processor (22) is arranged when calculating a plurality of dominant colors, to perform an analysis of the color content of the frames (10).

10. A system according to claim 7, wherein each dominant color comprises a representation in 3-dimensional color space.

11. A system according to claim 10, wherein the processor (22) is arranged, when determining the dominant color in the subset (18) of frames (10), with the largest difference from the closest dominant color in the series (14) of frames (10), to resolve a Euclidian distance for each dominant color.

12. A system according to claim 7, wherein the processor (22) is further arranged to generate a value, the value relating to the determined dominant color in the subset (18) of frames (10) with the largest difference from the closest dominant color in the series (14) of frames (10), and defining the extent of the difference.

13. A computer program product on a computer readable medium for processing an image signal, the product comprising instructions for:
receiving an image signal comprising a series (14) of frames (10),
calculating a plurality of dominant colors, over the series (14) of frames (10),
selecting a subset (18) of frames (10) of the image signal,
calculating a plurality of dominant colors, over the subset (18) of frames (10),
comparing the dominant colors of the subset (18) of frames (10) to the dominant colors of the series (14) of frames (10), and
determining the dominant color in the subset (18) of frames (10) with the largest difference from the closest dominant color in the series (14) of frames (10).

14. A computer program product according to claim 13, wherein the image signal further comprises data (16) comprising color information, and the instructions for calculating a plurality of dominant colors include instructions for accessing the data (16).

15. A computer program product according to claim 13, wherein the instructions for calculating a plurality of dominant colors include instructions for performing an analysis of the color content of the frames (10).

16. A computer program product according to claim 13, wherein each dominant color comprises a representation in 3-dimensional color space.

17. A computer program product according to claim 16, wherein instructions for determining the dominant color in the subset (18) of frames (10), with the largest difference from the closest dominant color in the series (14) of frames (10) comprises instructions for resolving a Euclidian distance for each dominant color.

18. A computer program product according to claim 13, and further comprising instructions for generating a value, the value relating to the determined dominant color in the subset (18) of frames (10) with the largest difference from the closest dominant color in the series (14) of frames (10) and defining the extent of the difference.
